(19) United States
(12) Patent Application Publication
(10) Pub. No.: US 2016/0217112 A1
(43) Pub. Date: Jul. 28, 2016

(54) User-Initiated Data Recognition and Data Conversion Process

(71) Applicant: CHARTSPAN MEDICAL TECHNOLOGIES, INC., Greenville, SC (US)

(72) Inventors: Jon-Michial Carter, Greenville, SC (US); David Van Lawless, Greenville, SC (US); Ilya Evdokimov, Fremont, CA (US)

(73) Assignee: ChartSpan Medical Technologies, Inc., Greenville, SC (US)

(21) Appl. No.: 14/917,636

(22) PCT Filed: Sep. 25, 2014
(86) PCT No.: PCT/US2014/057459

§ 371 Date: Mar. 9, 2016

Related U.S. Application Data
(60) Provisional application No. 61/882,522, filed on Sep. 25, 2013.

(51) Int. Cl. G06F 17/22; G06F 3/0488; G06F 17/30; G06F 3/0484

(52) U.S. Cl. CPC G06F 17/2264; G06F 17/2247; G06F 3/04842; G06F 3/0488; G06F 17/30705

(57) ABSTRACT

A user-initiated data recognition and data conversion process allows for the conversion of unstructured data to structured data from a capture of an optical character recognition image with the unstructured data underneath. A method for converting unstructured data to structured data includes uploading a digital representation of a document to an optical character recognition server, scaling the digital representation of the document to fit the display size of a mobile device, using a touch interface to select unstructured data from the scaled digital representation of the document, populating the selected unstructured data in an electronic record to create structured data, and storing the structured data on a remote server.

### BACKGROUND OF THE INVENTION

1. Field of the Invention

This invention relates to the field of data recognition and Data Conversion and more specifically to the field of user-initiated data recognition and Data Conversion from digital transfers/representations of physical documents on a mobile device.

2. Background of the Invention

Physical documents suffer many well-known drawbacks. For example, transferring a physical document from one location to another requires the physical transfer of the document. Moreover, should the physical document be requested, it would also need to be retrieved. The use of digital documents provides solutions to these common issues. However, the transfer of information from a physical document to a digital format may be time-consuming and costly. Data integration solutions have been developed that may mitigate the time and expense of data transfer, however these solutions rely on the physical documents possessing a common template or format in order to automate the process. Outside of these common templates, the automation process may not function (i.e., the data may not be isolated and extracted) on a mobile device.

Consequently, there is a need for an improved data recognition and Data Conversion process that may recognize, isolate, and extract data from a variety of document templates or formats.

### BRIEF DESCRIPTION OF THE DRAWINGS

For a detailed description of the preferred embodiments of the invention, reference will now be made to the accompanying drawings in which:

FIG. 1 is a flow chart of the operation used to capture, record, highlight, and structure data from an image; and

FIG. 2 is a screen shoot of the X1, Y1, X2, and Y2 coordinates being captured by the User-Initiated Data Recognition and Data Conversion software.

### BRIEF SUMMARY OF SOME OF THE PREFERRED EMBODIMENTS

These and other needs in the art are addressed in one embodiment by a User-Initiated Data Recognition and Data Conversion Process that comprises an application for a media device that captures, uploads, or obtains an image to structure and save for further use by third parties. In embodiments, the User-Initiated Data Recognition and Data Conversion Process comprises the use of a document, such as a record or image, an User-Initiated Data Recognition and Data Conversion application comprising an interface, a storage server, and an optical character recognition server.

In embodiments, a method may be used with the User-Initiated Data Recognition and Data Conversion software for converting unstructured data to structured data. This method comprises capturing a digital representation of a document, uploading the digital representation to an optical character recognition server, scaling the digital representation of the document to provide a scaled digital representation of the document, wherein the scaled digital representation of the document fits a display size of a media device. Selecting the unstructured data from the scaled digital representation of the document, via a touch interface, populating the selected unstructured data in an electronic record to create structured data, and storing the structured data on a remote server.

In embodiments, a system for using User-Initiated Data Recognition and Data Conversion software for converting unstructured data to structured data may comprise a media device, a physical document, an application comprising an interface, a storage server, and an optical character recognition server. The system may further comprise the media device capturing a digital representation of a document, uploading the digital representation to an optical character recognition server, scaling the digital representation of the document to provide a scaled digital representation of the document, wherein the scaled digital representation of the document fits a display size of the mobile device, selecting unstructured data from the sealed digital representation of the document, via a touch interface, populating the selected unstructured data in an electronic record to create structured data, and storing the structured data on a remote server.

The foregoing has outlined rather broadly the features and technical advantages of the present embodiments in order that the detailed description that follows may be better understood. It should be appreciated by those skilled in the art that the conception and the specific embodiments disclosed may be readily utilized as a basis for modifying or designing other embodiments for carrying out the same purposes of the present invention.

### DETAILED DESCRIPTION OF THE PREFERRED EMBODIMENTS

In embodiments, the User-Initiated Data Recognition and Data Conversion Process may comprise software, a media device, a server, and an optical character recognition server. The media device may be a mobile media device or a stationary media device. Without limitation, examples of a suitable media device may include mobile phones, personal digital assistants, desktop computers, tablets, notebooks, and the like. In embodiments, the media device is a mobile phone. In embodiments, there is an interface on the media device. An interface, a part of the User-initiated Data Recognition and Data Conversion Process software, may be used on any media device. The interface may provide the user a choice between photographing, scanning, or uploading a record via the User-Initiated Data Recognition and Data Conversion software. It is to be further understood that an interface refers to a Graphical User Interface that allows users to interact with electronic devices through graphical icons and visual indicators.

The record may be any medium containing information and/or data. Records may comprise medical documents, immunization documents, family history documents, bank documents, school documents, or any documents used for information and for data recording purposes. Records may further comprise drawings, photos, notes, handwritten notes, or any combination thereof. The photographed or uploaded document is the original image. The record is saved on the media device or on a device connected to the media device. It is to be understood that connected includes physical connection and/or wireless connection. In embodiments, the original image may then be transferred via the internet, a digital network, wireless network, cabled network, closed network, or any other suitable network or combination thereof to an offsite server. In some embodiments, the original image is transferred to more than one offsite server. In embodiments, the offsite server may be of any type (e.g. cloud based) provided that the offsite server is capable of storing the original or processed images. In embodiments, the original image may be transferred via the internet, a digital network, wireless network, cabled network, closed network, or any other suitable network or combination thereof, directly from the media device or offsite server, to one or more optical character recognition (OCR) servers. In embodiments, the OCR server(s) may process the original image to produce a processed image, with unstructured data. It is to be understood that an OCR server recognizes numbers, letters, characters, and the like on a record and creates unstructured data that represents the number, letter, character and the like. Unstructured data refers to information that does not have a pre-defined data model or is not organized in a pre-defined manner. The unstructured data may allow a user to manipulate the data in any desirable way for further use. A processed image refers to an image that has been run through the OCR process and has had unstructured text data retrieved from the image. The processed image is returned via the internet, a digital network, wireless network, cabled network, closed network, or any other suitable network or combination thereof to a media device where it may be viewed.

In embodiments, the User-initiated Data Recognition and Data Conversion software may utilize an algorithm to scale the processed image to the respective screen size of a media or mobile device. In embodiments, the User-Initiated Data Recognition and Data Conversion software utilizes an algorithm to mathematically compute the ratio and scaling of the original image of the processed digital document scaled to the display size of a respective media device. In embodiments, this mathematical computation is stored as the “multiplier.” The “multiplier” may be used to scale up or scale down, according to the screen the document is being displayed on.

In some embodiments, the processed image may be viewed by the user on their respective media device. In embodiments, the user may be able to reposition the processed image and to “zoom in” or “zoom out” of the viewing perspective of the processed image. A user may “zoom in” using their fingers, touching the screen and sliding the fingers toward each other. “Zooming out” may be accomplished by touching the screen with the user's fingers and sliding the fingers away from each other. Furthermore, “zooming in” and “zooming out” may be accomplished with a peripheral device attached to the media device, such as a mouse. Using the peripheral device functions, the user may increase or decrease the size of the image, such as spinning a mouse wheel forward to increase and backward to decrease the size of the image. In embodiments, the processed image may be aligned with or may overlay the corresponding unstructured data of the original image. In embodiments, the processed image may be locked in place to the perspective of the aligned unstructured data. Locked in place refers to aligning the image to the top and left (X and Y respectively) coordinates and scaling the image while still keeping the original references to the image and OCR data in a un-zoomed state. In an embodiment, this locked in place perspective may allow the user to move or alter the perspective of the processed image without separating the aligned unstructured data or altering the scaling of the processed image.

In embodiments of the User-Initiated Data Recognition and Data Conversion Process. on the media device, a user may highlight or select text, images, or data from the processed image. In some embodiments, the user may use a touch interface on the media device to select or highlight the text, images, or data from the processed image. In alternative embodiments, the user may use a mouse, keyboard, etc. to select or highlight the text or data. In still further embodiments, text may be automatically highlighted and selected by an OCR Server. The user may then approve, or remove, the selection. Approving or removing the selection may be accomplished when the user is prompted to answer “yes” or “no”. If the user chooses “yes”, the selection is approved and stored on a server or media device. If the user chooses “no”, the selection is removed from the field, which allows the user to highlight additional text, images, or data from the processed image to fill the field. The area in which the user highlights is the boundary box. The user may alter the size and shape of the boundary box to encompass more or less text. This may be accomplished as described above, using the same operation as was used for the “zoom in” and “zoom out” features. Moreover, the position of the boundary box may be moved to select or highlight a new area or selection of text, image, or data.

In further embodiments of the User-Initiated Data Recognition and Data Conversion Process, once the text selection and highlighting process is complete, the User-Initiated Data Recognition and Data Conversion software may use algorithms to calculate the top, left, right, and bottom coordinates of the boundary box. The algorithm accomplishes such calculation by—defining the top and left coordinates then calculating the width and height of the box and programmatically creating a boundary box. The selected or highlighted text, image, or data made up by the calculated coordinates is therefore defined by the perimeter of the boundary box. In embodiments, the coordinates of the boundary box are multiplied by the multiplier. In embodiments, multiplication of the boundary box coordinates by the multiplier reverses the scaling of the OCR processing and thus, the original 1:1 image coordinates of the corresponding aligned boundary box coordinates may be isolated. In embodiments, once the original image coordinates are calculated, the User-Initiated Data Recognition and Data Conversion software structures the highlighted data out of the unstructured data, displaying the structured data, images, or text. Structured data refers to information that either has a pre-defined data model or is organized in a pre-defined manner. The structured data, images, or text may then be used to populate a new electronic document or record. The electronic document or record may be retrievable within the User-Initiated Data Recognition and Data Conversion software. The documents or records may be retrieved by selecting a prompt on the interface. For example, the prompt might indicate, “Records”. Selecting this prompt may take the user to a screen or screens for the collection of documents or records from which the user may choose. Choosing a document or record, the User-Initiated Data Recognition and Data Conversion software may access the document or record from a server, on which the document or record is saved.

In embodiments of User-Initiated Data Recognition and Data Conversion Process, the original image, the processed image, and the structured data are all stored on servers, or a server. In embodiments, the original image, the processed image, and the structured data may be recalled or retrieved by a user from the servers at any time. In embodiments, the original image may be transferred to the OCR servers, the processed image may have text or data selected and isolated, and/or the structured data may be altered or amended at any time after or during storage of the original image, processed image, and/or the structured data.

In embodiments of User-Initiated Data Recognition and Data Conversion Process, the processed image may be converted to any suitable document format, which includes, but is not to be limited to: Text, HTML, XML, XHTML, PDF, etc. In embodiments, the format may be any format that allows for the location of each text to be located on the page. In embodiments, the OCR servers may process the original image to provide top/left/right/bottom coordinates for each letter of the processed image. Further, the OCR servers may process the original image to provide top/right/left/bottom coordinates, bottom/left/top/right, left/top/bottom/right coordinates, right/bottom/top/left, or any combination thereof. In some embodiments, the User-Initiated Data Recognition and Data Conversion software may scale the processed image to adjust to the display size of any media device capable of displaying the processed image.

Embodiments of User-Initiated Data Recognition and Data Conversion Process also include that the selected or highlighted text may be populated in real-time, in a modal window within the interface. In embodiments, the modal window may be any viewing window of any size or shape that populates the selected or highlighted text in order to display to the user the portion of the text isolated by the user. In some embodiments, the modal window may always be present. In other embodiments, the modal window may only appear once a user has begun the text selection process. In embodiments, the user may be able to confirm the selected data or text once they are finished selecting or highlighting the text. In optional embodiments, the user may be able to confirm their selection via an interface prompt.

In some embodiments of User-Initiated Data Recognition and Data Conversion Process, the user may be prompted to select a specific type of text according to a category generated by the User-Initiated Data Recognition and Data Conversion software. Examples may include, but should not be limited to: dates, names, addresses, notes, and the like. In an embodiment, the user may be prompted to isolate medical record data according to the categories of: date of encounter, doctor name, ailment, diagnosis, prescribed medication, and physician/doctor notes, and the like. In alternative embodiments, the user may be able to select a picture, chart, graph, and the like. In these embodiments, the user may select text in addition to or at the exclusion of the picture, chart, graph, and the like. In further embodiments, the user may be able to initiate and label their own categorical prompts. Upon the selection of text for a category, the user may be able to approve of the selection. If the user does not approve, the user may delete the selection and select the data again.

In embodiments of User-Initiated Data Recognition and Data Conversion Process, the structured data may be used to populate an electronic document or record. In optional embodiments, the structured data may be searchable. This data may be searchable through a full text search. Full text search refers to the capability to identify natural-language documents that satisfy a query, and optionally to sort them by relevance to the query. In optional embodiments, the structured data may undergo further processing within the User-Initiated Data Recognition and Data Conversion software. In further optional embodiments, structured data may be, obtained from records used for further processing in other applications. Other applications may include, but are not limited to, applications involving bank records, insurance records, family records, doctor records, house records, cooking records, receipt records, legal records, engineering records, licensing records, and the like. In optional embodiments, the structured data or the electronic record or document may be transferred to a third party or device (i.e., emailed or faxed from the mobile device to a desired receiver such as a doctor or school). For example, school administration may want to see a child's immunization records. The parent using User-Initiated Data Recognition and Data Conversion software may take a picture of the record, highlight appropriate immunization data, place that data in fields, and save the record. The parent may then send the record as a file by email or any other electronic means to the appropriate administrator. The administrator may then access the file, revealing the record and fields with appropriate immunization information.

Additional embodiments of User-Initiated Data Recognition and Data Conversion Process include, once all or about all of the data selected from the user has been isolated and retrieved, the user may create a named record for the permanent, structured data document. In embodiments, the original image, the processed image, and the structured data may be stored securely on a remote server. The information may be encrypted. Encryption refers to the process of encoding messages or information in such a way that only authorized parties can read it. In embodiments, the original image, the processed image, and the structured data may be sorted and organized within the interface of the User-Initiated Data Recognition and Data Conversion software. In embodiments, the user may categorize the data according to their personal preferences or by the type of data/record that the user has chosen to create. In an embodiment, prompts may, be used to help the user categorize the data according to their personal preferences or by the type of data/record that the user has chosen to create. The image uploaded to the OCR server and data generated by the OCR process is deleted. The original image, structured data, and unstructured data may be saved on an offsite server separate and apart from the OCR server.

In embodiments of User-Initiated Data Recognition and Data Conversion Process, the User-Initiated Data Recognition and Data Conversion software may be used for recognizing, isolating, and converting data from any document. In embodiments, the User-Initiated Data Recognition and Data Conversion software may be used to recognize, isolate, and convert data from document types that do not share a common template or format. In some embodiments, the User-Initiated Data Recognition and Data Conversion software may be used for unstructured data that, due to inherent formatting variations, may not be converted or may be difficult to convert to structured data via an automated conventional process. In specific embodiments, the User-Initiated Data Recognition and Data Conversion software may be used to recognize, isolate, and convert medical data from medical records and documents.

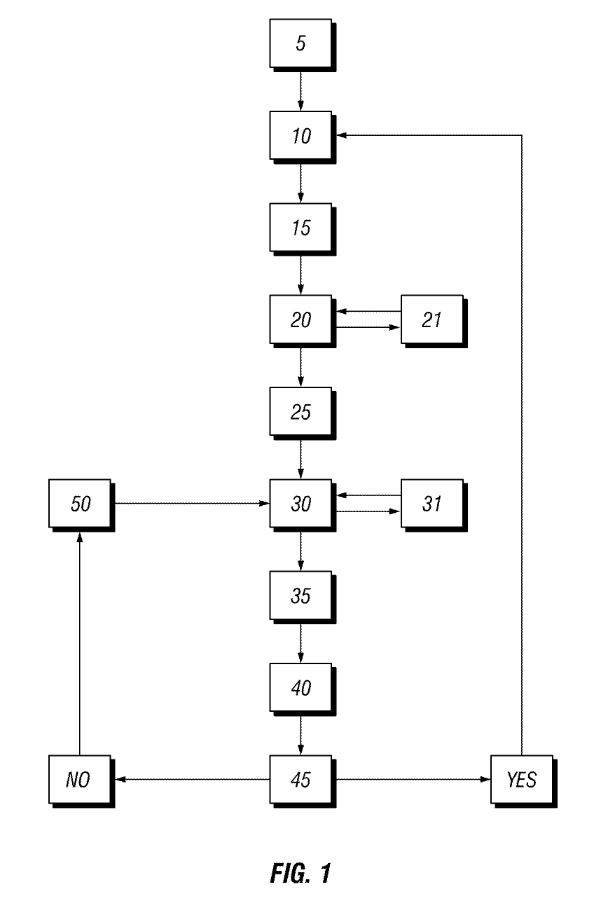

FIG. 1 illustrates an embodiment of the operation of the User-Initiated Data Recognition and Data Conversion system. Block 5 is the beginning of the operation when a user photographs, scans, or uploads a record onto a media device. The image uploaded and/or scanned is saved on the media device and sent to a server where the document is saved on the server, block 10. Block 15 represents the image being sent from the server to an OCR server for processing. The OCR server converts the image into unstructured data. The unstructured data is sent back to the user's media device in block 20. Block 21 represents the user “zooming in” or “zooming out” of the document, adjusting the document to fit the display screen. Fields are produced by the User-Initiated Data Recognition and Data Conversion software for the user to fill in block 25. Block 30 is when the user highlights the parts of the image to fill the request fields. Block 31 represents the “multiplier”, which reverses the scaling of the image in block 21. Highlighting the different parts of the image turns the unstructured data representing that specific part of the image into structured data, as represented by block 35. The structured and highlighted data is then placed into a designated field in block 40. Block 45 represents the user choosing if the populated fields are correctly populated. If the fields are not correctly populated, for example the wrong information was highlighted, the user may select “No”. Selecting “No” moves the operation to block 50, which deletes the selected structured data from the corresponding fields. The operation then reverts back to block 30, where the user highlights the parts of the image to fill the requested field. The operation may be repeated as desired until the field is correctly populated. Once correctly populated, the user may select “Yes” which stores the structured data on a server or media device for further use. Further use may include sending the image and structured data, now associated with specific fields, to doctors, schools, teachers, nurses, and the like for review.

In another embodiment of operation of the User-Initiated Data Recognition and Data Conversion system, a user photographs or uploads a record on to a media device that uses User-Initiated Data Recognition and Data Conversion software. The file created by the record is uploaded via the internet, a network, or wireless network, to a server for storage. The URL, or location of the file on the server, is passed to an Optical Character Recognition (OCR) server for processing. The OCR server processes the image and returns OCR data via the internet, a network, or wireless network in XML format (or other desired format) with top/left/right/bottom coordinates for each letter. The media device, using User-Initiated Data Recognition and Data Conversion software, resizes the original image to fit the media device. An algorithm mathematically computes the ratio and scaling of the original image scaled down to fit on the media device. The scaling is stored as a “multiplier”. The resized image is shown to the user with aligned unstructured data hidden behind the image. The image is perfectly aligned with the corresponding unstructured data for all field names including date of encounter, doctor name, ailment, diagnosis, prescribed medication(s), and physician/doctor notes.

Using a touch interface, the user then highlights the relevant data on the original image. During the highlight motion by the user, the selected highlighted area populates, in real-time, with the unstructured text behind the image. Once highlighting is complete, the User-Initiated Data Recognition and Data Conversion software uses an algorithm to calculate the top, right, bottom, and left coordinates and create a rectangle around the data. The top, right, bottom, and left coordinates are then multiplied by the “multiplier” that was calculated previously in order to return the top, right, bottom and left coordinates back to the original 1:1 values that the OCR data returned. Once the 1:1 coordinates are calculated, the User-Initiated Data Recognition and Data Conversion software, in real time, returns the XML data returned from the COR servers that contain the processed text. This text is then populated into the requested field, and the user is prompted to highlight the next field in the list. Once all the fields are populated, a new record is created that saves the data entered and stores the saved data with the associated image that the user uploaded. This record may then be retrieved inside the User-Initiated Data Recognition and Data Conversion software.

Described below are the prompts that a user may see when using the User-Initiated Data Recognition and Data Conversion system software. The user may first download the User-Initiated Data Recognition and Data Conversion software from a third party server to a media device. In other embodiments, the user may upload the User-Initiated Data Recognition and Data Conversion software from a peripheral device such a CD, USB, or other mass media device. Once the software is loaded, the user may be required to activate the software with an encryption key or password. Activating the software, the user may click “Create a Record Button”. The user then has the option to “Photograph Your Record” or “Import Your Electronic Record”. Selecting the appropriate option, the software retrieves an image either through a media device camera, through an Image Gallery, or from a computer hard drive. Once the image is selected, it is shown to the user with the User-Initiated Data Recognition and Data Conversion software interface. The user is prompted to highlight the data that corresponds to the first data input field, for example “Date of Encounter”. Once the user highlights the text, they are shown the data and may confirm their choice. If they confirm their choice, the data they selected is entered into the input field for the field name. This process is repeated as desired to fill all data input fields. Once the desired input fields are populated, the user may give the record a name, creating a permanent structured data document. The structured data record, the image, and the unstructured OCR data are all saved.

In embodiments of the User-initiated Data Recognition and Data Conversion system, a user may navigate to the “Add Record” page. The user is given the option to choose from “Photograph Your Record” or “Import Your Electronic Record”. If the “Photograph Your Record” prompt is chosen, the User-Initiated Data Recognition and Data Conversion software loads the native camera in the media device. If the “Import Your Electronic Record” prompt is chosen, the native “Gallery” is accessed through the media device. This functionality is provided through a framework program. A framework program is a platform that is used to develop and test software for computer programs. Examples of a framework program may include programs such as “Trigger.io”.

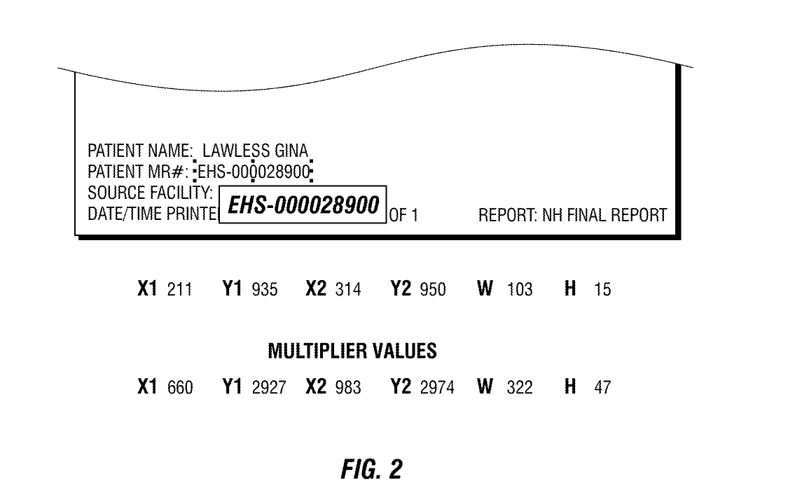

On a desktop computer, the user is given a “File Upload” input field, a HTML functionality. The user photographs a record, uploads the record, or selects the record, the image file is passed through the framework program. The image is then loaded to the “Add Record” page of the User-Initiated Data Recognition and Data Conversion software, where it is scaled to fit the media device. An algorithm for scaling in the User-Initiated Data Recognition and Data Conversion software is used to calculate how much the image has been scaled down from the original size in order to create a “multiplier” value that may be used to correct the coordinates that the user highlights. The User-Initiated Data Recognition and Data Conversion software prompts the user to highlight the first relevant data field from the selected image. As illustrated in FIG. 2, the User-Initiated Data Recognition and Data Conversion software allows the user to highlight an area on the image and return X1, Y1, X2, Y2. The width and height values for the user-defined highlights are X1, Y1, X2, Y2, which define the top, right, bottom, and left coordinates of the user-defined rectangle. The X1, Y1, and height coordinates are used to display the selected text, displaying the text below the highlighted area, as illustrated in FIG. 2. Once the user highlights the text, X1, Y1, X2, and Y2 values are multiplied by the previously defined “multiplier” to return the values to the XML documents 1:1 sizing. The user selected data is populated into HTML input fields using as suitable programming language. A commercial example of a programming language is JavaScript®, which is a registered trademark of Sun Microsystems, Inc. The user further manually inputs the data that is stored in standard HTML input fields. The new record is sent via “API” to a server to be stored as part of the user's account. “API” refers to an Application Programming Interface. An API is a specification of remote calls. Its main purpose is to define a set of functionalities that are independent of their respective implementation, allowing both definition and implementation to vary without compromising each other. While API may be used to transport data between a server and media device, it should be noted that other forms of transfer may be used to transport data between the media device and server. The storage server may be a cloud storage back-end database.

Although the present invention and its advantages have been described in detail, it should be understood that various changes, substitutions and alterations may be made herein without departing from the spirit and scope of the invention.

1. A user-initiated data recognition and data conversion system for a record, comprises:
an interface, wherein the interface is disposed on a media device;
a server;
an optical character recognition server, wherein the optical character recognition server processes a record into an unstructured data compilation.

2. The user-initiated data recognition and data conversion system of claim 1, wherein information from the server is transmitted to the optical character recognition server.

3. The user-initiated data recognition and data conversion system of claim 2, wherein after information is transmitted to the optical character recognition server, the information is compiled into the unstructured data.

4. The user-initiated data recognition and data conversion system of claim 3, wherein the unstructured data is transmitted to the storage server.

5. The user-initiated data recognition and data conversion system of claim 4, further comprising manually selected data, wherein the manually selected data provides a user access to the interface to manually select data returned from the optical character recognition server.

6. The user-initiated data recognition and data conversion system of claim 5, wherein the manually selected data is structured data from the unstructured data.

7. The user-initiated data recognition and data conversion system of claim 5, further comprising highlighted data.

8. The user-initiated data recognition and data conversion system of claim 7, wherein the highlighted data is sized by a multiplier.

9. The user-initiated data recognition and data conversion system of claim 8, wherein the structured data comprises the highlighted data, and wherein the structured data is sent to a third party device.

10. A method for converting unstructured data to structured data, comprising:
(A) obtaining a digital representation of a document;
(B) uploading the digital representation to an optical character recognition server;
(C) scaling the digital representation of the document to provide a scaled digital representation of the document, wherein the scaled digital representation of the document fits a display size of a media device;
(D) selecting unstructured data from the scaled digital representation of the document, via a touch interface, which provides selected unstructured data;
(E) populating the selected unstructured data in an electronic record to create structured data; and
(F) storing the structured data on a remote server.

11. The method of claim 10, wherein capturing a digital representation of a document is accomplished by a mobile device.

12. The method of claim 10, wherein the selecting of the unstructured data is accomplished by highlighting the unstructured data.

13. The method of claim 12, further comprising populating the selected unstructured data into structured data when a user selects specific data.

14. The method of claim 13, further comprising placing the structured data into a plurality of fields for the user to view.

15. The method of claim 14, further comprising accepting or removing the structured data that has been placed into fields.

16. The method of claim 15, further comprising storing the accepted structured data on a mobile device.

17. The method of claim 15, further comprising removing unaccepted structured data from the field.

18. The method of claim 17, further comprising selecting additional structured data after the field has been removed of previously selected structured data.

19. The method of claim 10, wherein the scaling of the document produces a multiplier.

20. The method of claim 19, further comprising scaling up or down structured data with the multiplier.
